(19) United States
(12) Patent Application Publication
(10) Pub. No.: US 2007/0028748 A1
(43) Pub. Date: Feb. 8, 2007

(54) Instantaneous sight recognition system for music

(76) Inventor: Cliff Miles, Orem, UT (US)

Correspondence Address: TRASK BRITT, P.O. BOX 2550, SALT LAKE CITY, UT, 84110, US

(21) Appl. No.: 11/199,473

(22) Filed: Aug. 8, 2005

(51) Int. Cl. G09B 15/02

(52) U.S. Cl. 84/483.2

(57) ABSTRACT

This invention provides a system of notation whereby a musical composition may be graphed accurately without dependence upon the use of a key signature or accidentals. One reading a printed copy of a composition is informed instantaneously of the exact pitch of each note without the need for remembering the key in which the composition is written. The system involves consistently associating a specific color with a selected shift in pitch with respect to the literal staff position indicated by the position of a printed note symbol.

### BACKGROUND OF THE INVENTION

1. Field of the Invention

This invention pertains to music notation. It is particularly directed to an alternative system for the notation of western music based upon the tempered diatonic scale, although its teachings are more broadly applicable.

2. State of the Art

Systems for the notation of western music have evolved over the past millennium. Western music is conventionally based upon a “tempered” diatonic scale, that is, a scale in which an octave is divided into twelve evenly spaced semitones. The harmonic system upon which most western music is based, however, divides the same octave into two tetra chords, specifically do-re-mi-fa and so-la-ti-do, separated by the whole step: fa-la. The construction of triads at each degree of a scale thus produces a non-repeating series of chords. Identifying each scale degree by a roman numeral, a minor interval as “m” and a major interval as “M,” beginning students learn the following construction of triads:

| | | | |
|---|---|---|---|
| I | do | Mm | (1^{st}, 3^{rd}, 5^{th}) |
| II | re | mM | (2^{nd}, 4^{th}, 6^{th}) |
| III | mi | mM | (3^{rd}, 5^{th}, 7^{th}) |
| IV | fa | Mm | (4^{th}, 6^{th}, 8^{th}) |
| V | so | Mm | (5^{th}, 7^{th}, 9^{th}) |
| VI | la | mM | (6^{th}, 8^{th}, 10^{th}) |
| VII | ti | mm | (7^{th}, 9^{th}, 11^{th}) |

The parenthetical Arabic numerals in the table designate the scale tones of each triad, with “8^{th}” being an octave higher than “1^{st}.” Significantly, these scale tones comprise an eight-tone scale, rather than the twelve-tone (chromatic) scale upon which western music is actually based. This difference is explained by the reality that each major interval embraces two semi-tones. The existence of these major intervals imposes the necessity for a notation system to be capable of indicating the semi-tones of the chromatic scale not included in the eight-tone scale. Modem instruments (and the human voice) are capable of producing these semi-tones (in essence, the black keys of a piano keyboard, in the case of a C major scale.)

Music notation is symbolic in nature, typically reflecting rhythm, melody and harmonic structure with reference to printed staffs. These staffs are conventionally regarded as comprising segments of a more comprehensive “grand staff.” A music staff comprises a plurality of parallel lines, each of which represents a specified pitch (selected audible frequency) within a musical scale (conventionally in the key of C major). The spaces between staff lines represent intermediate pitches within the same musical scale. The lines and spaces may be termed “staff positions,” and are arranged to correspond to each whole tone and semitone (scale degree) of a musical scale. As the use of staffs became common, it became conventional practice to utilize vertical bar lines to divide them into measures of prescribed duration.

Historically, the appropriate pitch, rather than a specified scale degree, has sometimes been assigned to each line and space in a staff. According to this convention, the staff position corresponding to any given pitch remains constant. Players of transposing instruments (those pitched in keys other than C) are trained to use a different fingering to sound a designated pitch, in essence, performing the transposing function mentally. It requires less skill, however, and has thus became conventional practice, to assign specific scale degrees to each staff position and to provide players of transposing instruments written music with individual note symbols transposed to the staff positions appropriate for the pitch of their respective instruments.

Because the audible range of music extends for several octaves, the grand staff is divided into segments representing different standardized frequency bands. These staff segments are indicated by clef symbols, the most common in current use being the treble, alto and bass clefs. The pitch commonly designated “middle C” is represented by the staff position corresponding to the middle line of the alto clef. This line is positioned one space below the lines of the treble clef and one space above the lines constituting the bass clef. A shortcoming of any staff comprising the grand staff is that the staff positions correspond to the eight-tone C major scale, rather than the twelve-tone chromatic scale. Five semitones (C#, D#, F#, G#, A#) of the chromatic scale cannot be literally indicated by the mere positioning of a note symbol with respect to a staff. Additional visual indicators are required to display accurately a composition including these semi-tones. The system currently in standard use is to apply “accidental” symbols to a staff position, indicating that the immediately following note symbol is not to be taken literally, but rather, is intended to represent an adjacent semi-tone (just above, in the case of the sharp symbol, “#”; just below, in the case of the flat symbol, “b”).

The staff system may be regarded as a means for the graphical representation of music. Symbolic “notes” and “rests” divide each measure of the staff, indicating the duration of “struck” (or otherwise “sounded”) tones and intervals of silence, respectively. Note symbols are positioned upon the staff to designate the scale degree (and thereby the pitch) of each note of a melody. Pitches outside the scale of the staff—e.g., the five semitones with no designated staff positions—are designated by “accidental” signs, positioned just prior to a note symbol, indicating that the pitch corresponding to a scale degree of that note symbol should be either raised (sharped) or lowered (flatted), typically by a semitone. Graphed accidental signs are easily misread, but in any case crowd the visual display of the staff. A composition written in a scale requiring several semitones not present in the C scale becomes virtually unreadable when all of the accidental signs are displayed. Moreover, note symbols are displayed in varying contexts. The rules applicable to the use and effect of accidental signs in these contexts were historically a matter of personal choice by a composer. A consistent convention for the application and use of accidental signs has evolved, but adherence to these rules requires diligence and effort. For example, one reading music including accidental signs must keep in mind that an accidental; applies only to the staff position first stated. The same note in a different octave or on a different staff remains played as written; an accidental applies only until the occurrence of a bar-line or another accidental on the same staff position; a bar-line does not, however, terminate an accidental in the case of a tied-note symbol, although the accidental does not apply to the same staff position beyond the tied note symbol. These rules are inconsistent with key signatures, which are understood to apply generally to all staff positions, octaves and staffs. Even experienced musicians can become confused about the proper interpretation of accidental signs.

It is possible to assign pitches to staff positions appropriate to keys other than C major. As a practical matter, however, the C major staff has been adopted as standard. Accordingly, the fundamental pitch of the displayed staff is changed to keys other than C through the use of key signatures. In essence, the use of key signatures avoids the need for repetitive accidentals to graph (or display) compositions of various keys on the standard staff. This simplicity of notation, however, imposes upon one translating the musical composition (through performance or otherwise) the need to remember which note symbols to play either sharp or flat (compared to their respective displayed positions.) Of course, the use of key signatures does not avoid the need for graphically symbolizing accidentals that result from compositional choices other than key selection.

Accomplished musicians and serious students of music inevitably become familiar with the harmonic structure of music, including the major and minor scales. It may not impose a significant burden to require such individuals to remain aware of the applicable key signatures as they translate from the displayed staff positions of each note symbol to duplicate a composition. It eventually becomes “second nature” to insert mentally the shift in pitch required for particular notes by a key signature. For individuals with less interest or capability, however, the translation process may be difficult, discouraging or even inaccessible. The lack of direct correspondence between the twelve-tone scale and the grand staff imposes a significant learning barrier to a large segment of the public. Even individuals who are otherwise competent musicians sometimes have limited music reading skills.

Most academic music instruction systems emphasize the harmonic structure of music. Accordingly, it is the usual practice to remain true to the harmonic structure of a composition when presenting it in printed form. Inevitably, there are instances when an accidental (e.g., B#) that is appropriately displayed in accordance with the harmonic structure of a composition introduces confusion. Most beginning students or amateurs of limited music reading skill recognize the equivalent note symbol C more readily than the relatively obscure B#.

Color has been used as a guide to proper finger positioning in certain instructional systems for keyboard and fretted instruments. U.S. Pat. No. 6,831,220 discloses a system for converting black and white musical scores to colorized musical scores for use with such instruments. The “Lowrey Magic Organ Course” assigns specific colors to stripes printed above a staff to designate the harmonic accompaniment appropriate for the melody line displayed on the staff. Colors have also been incorporated into devices and systems that display colors in response to pitches or other characteristics of audible musical signals. U.S. Pat. No. 3,974,733 discloses the designation of root notes of specified chords by colors printed on a teaching device, similar in a structure to a slide rule. U.S. Pat. No. 6,831,219 discloses the correlation of the color spectrum to harmonic structure for either performance or instructional purposes. None of these proposals has freed a performer from the need to rely upon memory to provide pitch information not literally represented by a note symbol. There remains a need for a music notation system that offers a student or performer instant visual recognition that a displayed note symbol is intended, within the context of a musical composition, to be either sharped of flatted.

### BRIEF SUMMARY OF THE INVENTION

This invention provides a system of notation whereby a musical composition may be graphed accurately without dependence upon the use of a key signature or accidentals. One reading a printed copy of a composition is informed instantaneously of the exact pitch of each note without the need for remembering the key in which the composition is written. The system of this invention involves consistently associating a specific color with a selected shift in pitch with respect to the literal staff position indicated by the position of a printed note symbol. For example, the system may be embodied such that all notes displayed in red are understood to be sharped, while those displayed in green are understood to be flatted. More complex embodiments may associate other specific colors with quartertone sharps and flats, respectively.

In general, this invention may be regarded as an improved music notation system of the type that symbolically displays notes of a musical composition on a staff, such as the grand staff. The musical composition may contain any combination of semitones taken from multiple octaves of the chromatic scale. The staff characteristically provides staff positions corresponding to each scale degree of a major scale extracted from the chromatic scale, but lacks staff positions corresponding to other semitones of the chromatic scale. The notation system of this invention enables graphing musical compositions containing such other semitones without the use of key signatures or accidentals.

Musical compositions are commonly graphed by printing note symbols, rendered in a traditional color, notably black, on a printed staff. The staff is usually printed in the same traditional color. The system of this invention comprises associating specified colors with the routine transposing operations of either shifting the normal pitch of a displayed note by a semitone sharp with respect to the normal pitch of the displayed note or shifting the normal pitch of a displayed note by a semitone flat with respect to the normal pitch of the displayed note. These “transposing indicator” colors are readily distinguishable from traditional note colors; typically selected from the “rainbow colors” of the visible light spectrum. A first specified transposing color (e.g., red) is applied to each note of a printed version of a composition that is intended to be shifted in pitch in accordance with a first such transposing operation. A second specified color (e.g., green) is applied to each note of the printed version of the composition that is intended to be shifted in pitch in accordance with a second transposing operation. The most expedient manner of “applying” a transposing indicator color is to render the notes to be transposed in that color. Thus, a musical composition may be graphed on the grand staff in accordance with this invention by indicating each scale tone of the composition corresponding to a staff position by positioning a note symbol rendered in a first unique color (traditionally black) at that staff position; indicating each scale tone of the composition corresponding to a semitone sharp with respect to a staff position by positioning a note symbol rendered in a second unique color (e.g., red) at that staff position; and indicating each scale tone of the composition corresponding to a semitone flat with respect to a scale position by positioning a note symbol rendered in a third unique color (e.g., green) at that staff position. In all other respects, the note symbols are located and configured in accordance with conventional practice. In essence, each scale tone of a composition corresponding to a semitone having no assigned staff position is designated by positioning a note symbol rendered in a unique non-traditional note color at a staff position corresponding to an adjacent semitone. The non-traditional note color is indicative of a transposing operation effective to reveal the intended pitch of the semitone in question. By this means, scale tones one semitone sharp with respect to a staff position are designated by a note symbol positioned at that staff position and rendered in a specific color uniquely associated with the sharp transposing operation. Scale tones one semitone flat with respect to a staff position are designated by a note symbol positioned at that staff position and rendered in a specific color uniquely associated with the flat transposing operation

While this invention is described with specific reference to the conventional twelve-tone diatonic scale characteristic of classical western music, it is also applicable to the notation of music based upon other musical scale systems that utilize key signatures and/or accidentals. Certain embodiments of the invention are applicable to the notation of quartertone compositions, for example. Moreover, the present invention has application to compositions graphed upon staffs based upon either defined pitches or defined scale degrees.

The notation system of this invention avoids the need for key signatures or accidentals. Nevertheless, the display of note symbols rendered in specific unique colors to designate corresponding defined shifts in pitch may optionally be supplemental to more conventional notation systems. The conventional display of key signatures in no way diminishes the usefulness of the color-enhanced notation of this invention. The display of accidentals in a composition graphed (or notated) in accordance with this invention may introduce needless confusion, but is permissible, and may be useful, for example, in certain teaching situations.

### BRIEF DESCRIPTION OF THE DRAWINGS

The patent or application file contains at least one drawing executed in color. Copies of this patent or patent application publication with color drawings will be provided by the Office upon request and payment of the necessary fees.

In the drawings, which illustrate what is currently regarded as the best mode for carrying out the invention:

FIG. 1 illustrates a segment of a musical score written in the key of D, graphed upon a staff segment in accordance with this invention; and

FIG. 2 illustrates a segment of a musical score written in the key of Db, graphed upon a staff segment in accordance with this invention.

### DETAILED DESCRIPTION OF THE INVENTION

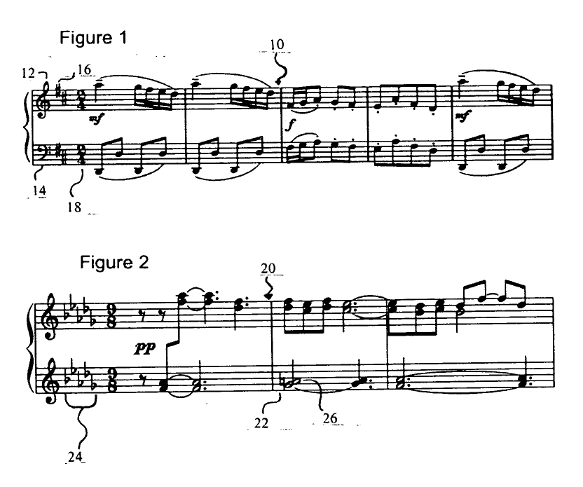

FIG. 1 comprises a staff segment, generally 10, arranged in conventional fashion with a treble clef 12 and a bass clef 14, a key signature 16 and a time signature 18. Each note occupying a staff position that the key signature indicates is intended to be transposed one semitone sharp (F and C at all octave positions) is rendered in green.

FIG. 2 is similar to FIG. 1, but comprises a staff segment, generally 20, upon which a composition written in the key of Db is graphically displayed. Each note occupying a staff position that the key signature indicates is intended to be transposed one semitone flat (B, E A, D and G at all octave positions) is rendered in red. Although a natural symbol 22 appears in conventional position to reflect an A natural (rather than the Ab required by the key signature 24, the transposition shift required by the symbol 22 is also indicated by rendering the note 26 in black. In the illustrated instance, all notes rendered in black are intended to be sounded in accordance with their respective literal staff positions.

What is claimed is:

1. In a music notation system of the type that symbolically displays notes of a musical composition on a staff that provides staff positions corresponding to each scale degree of a major scale but lacks staff positions corresponding to other semitones of the chromatic scale that includes said major scale, an improvement enabling graphing musical compositions containing such other semitones without the use of key signatures or accidentals, said improvement comprising:
associating a first specified color with a first transposing operation selected from the group consisting of shifting the normal pitch of a displayed note by a semitone sharp with respect to the normal pitch of said displayed note and shifting the normal pitch of a displayed note by a semitone flat with respect to the normal pitch of said displayed note; and
applying said first specified color to each note in a printed version of such a composition that is intended to be shifted in pitch in accordance with said first transposing operation.

2. An improvement according to claim 1, further comprising:
associating a second specified color with a second transposing operation selected from the group consisting of shifting the normal pitch of a displayed note by a semitone sharp with respect to the normal pitch of said displayed note and shifting the normal pitch of a displayed note by a semitone flat with respect to the normal pitch of said displayed note, said second transposing operation being non-identical to said first transposing operation; and
applying said second specified color to each note in a printed version of such a composition that is intended to be shifted in pitch in accordance with said second transposing operation.

3. An improvement according to claim 2, wherein said first and second specified colors are selected from the group consisting of the primary and secondary colors of the visible light spectrum.

4. An improvement according to claim 3, wherein said first color is red and said second color is green.

5. A method of notating a musical composition on the grand staff, comprising:
indicating each scale tone of said composition corresponding to a staff position by positioning a note symbol rendered in a first unique color at said staff position;
indicating each scale tone of said composition corresponding to a semitone sharp with respect to a staff position by positioning a note symbol rendered in a second unique color at said staff position; and
indicating each scale tone of said composition corresponding to a semitone flat with respect to a scale position by positioning a note symbol rendered in a third unique color at said staff position.

6. A method according to claim 5, wherein said first color is a traditional note color, and said second and third colors are different colors selected from the group consisting of rainbow colors.

7. A method of notating a musical composition on the grand staff, comprising:
indicating each scale tone of said composition corresponding to a staff position by positioning a note symbol rendered in a traditional note color at said staff position; and
indicating each scale tone of said composition corresponding to a semitone having no assigned staff position by positioning a note symbol rendered in a unique non-traditional note color at a staff position corresponding to an adjacent semitone; said non-traditional note color being indicative of a transposing operation effective to reveal the intended pitch of said semitone.

8. A method according to claim 7, wherein scale tones one semitone sharp with respect to a staff position are designated by a note symbol positioned at said staff position and rendered in a specific color uniquely associated with the sharp transposing operation.

9. A method according to claim 7, wherein scale tones one semitone flat with respect to a staff position are designated by a note symbol positioned at said staff position and rendered in a specific color uniquely associated with the flat transposing operation.
